(19) United States
(12) Patent Application Publication
(10) Pub. No.: US 2010/0153537 A1
(43) Pub. Date: Jun. 17, 2010

(54) METHOD AND APPARATUS FOR PROVIDING DETECTION OF INTERNET PROTOCOL ADDRESS HIJACKING

(76) Inventors: JIA WANG, Randolph, NJ (US); Lusheng Ji, Randolph, NJ (US); Dan Pei, Jersey City, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/333,287

(22) Filed: Dec. 11, 2008

(51) Int. Cl. G06F 15/16; G06F 21/00

(52) U.S. Cl. 709/224; 726/23

(57) ABSTRACT

A method and apparatus for detecting an address hijacking in a network are disclosed. For example, the method sends one or more traceroute packets to a target prefix, wherein the target prefix comprises one or more destination Internet Protocol (IP) addresses, and records traceroute data received for the one or more traceroute packets sent to the target prefix. The method then determines one or more hop count distance measurements for the target prefix, and determines if there are one or more changes in the one or more hop count distance measurements for the target prefix.

The present invention relates generally to communication networks and, more particularly, to a method and apparatus for providing detection of address hijacking in networks, e.g., Internet Protocol (IP) networks, Voice over Internet Protocol (VoIP) networks, Virtual Private Networks (VPN), and the like.

### BACKGROUND OF THE INVENTION

Hijacking Internet Protocol (IP) address prefix is a threat that disrupts the Internet routing infrastructure. Current hijacking detection approaches monitor IP prefixes on the control plane of a network and detect inconsistencies in route advertisements and route qualities. However, this approach requires a privileged access to live BGP feeds. However, in most networks only a very small number of nodes have live BGP update feeds.

### SUMMARY OF THE INVENTION

In one embodiment, the present invention discloses a method and apparatus for detecting an address hijacking in a network. For example, the method sends one or more traceroute packets to a target prefix, wherein the target prefix comprises one or more destination Internet Protocol (IP) addresses, and records traceroute data received for the one or more traceroute packets sent to the target prefix. The method then determines one or more hop count distance measurements for the target prefix, and determines if there are one or more changes in the one or more hop count distance measurements for the target prefix.

Alternatively, the method receives one or more: alarms, traceroute data, or hop count distance measurements from one or more monitors, and correlates the one or more: alarms, traceroute data, or hop count distance measurements from the one or more monitors. The method then determines whether an address has been hijacked for a target prefix.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with the current invention for providing detection of address hijacking;

FIG. 3 illustrates a flowchart of a method for a monitor providing detection of address hijacking; and

FIG. 4 illustrates a flowchart of a method for an application server providing detection of address hijacking; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing detection of address hijacking in networks. Although the present invention is discussed below in the context of Internet Protocol (IP) networks, the present invention is not so limited. Namely, the present invention can be applied for other packet networks, e.g., cellular networks and the like.

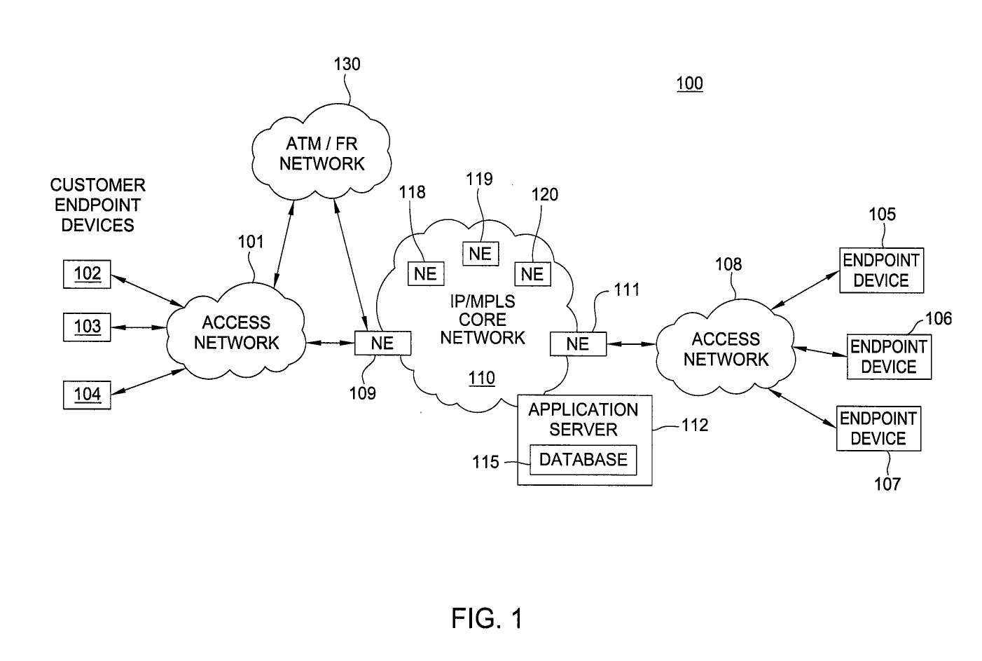

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, and so on are depicted in FIG. 1, the communication system 100 may be expanded by including additional endpoint devices, access networks, network elements, application servers without altering the scope of the present invention.

The above IP network is described to provide an illustrative environment in which packets for voice, data and multimedia services are transmitted on networks. As more and more IP prefix hijacking incidents are being reported, the need to maintain the integrity of routing information has increased. However, dynamic inter-domain routing protocols, e.g., Border Gateway Protocol (BGP), used in Internet Protocol (IP) based networks have no mechanism for authenticating routing announcements. Thus, misbehaved routers (e.g., routers performing the hijacking) can arbitrarily advertise routes for prefixes and/or fabricate Autonomous System (AS) paths associated with the prefixes. Such false announcements may quickly spread to a large number of BGP routers across multiple autonomous systems and pollute their routing tables. As a result, the victim network with hijacked prefix (prefixes) may experience performance degradation and a security risk.

For example, packets addressed to a hijacked prefix may be dropped by intermediate routers, may be dropped by the attacker; or may be forced to take a longer detour to reach their true destination. Furthermore, an attacker may impersonate the victim prefix to communicate with other parties, may send spam emails and/or launch denial of service attacks from the hijacked prefix, may intercept communications, or may conduct Man-in-the middle attacks.

One method to detect prefix hijacking is to monitor IP prefixes on the control plane. Monitoring IP prefixes on the control plane requires privileged access to live BGP feeds. However, in most networks only a very small number of nodes have live BGP update feeds. In addition, proposals based on passive monitoring suffer from a high number of false positive results. For example, a false positive may result when a legitimate routing change is mistaken for a hijacking. A false positive may also result when a routing registry or allocation data is outdated and inaccurate.

In one embodiment, the current method provides detection of address hijacking in a network. The method utilizes real-time data collected from the data plane. The method provides an advantage to network service providers by not requiring privileged access to live BGP advertisements. Independence from the BGP control plane also emancipates the hijacking detection mechanism from the updating cycles of BGP data collection points. The independence from the BGP updating cycles enables the network to create prefix hijacking alarms in a timely manner.

To better understand the current invention, the following networking terminology will first be provided:

Prefix;

An Autonomous System (AS); and

Border Gateway Protocol (BGP).

A prefix refers either to a set of IP addresses or a set of network devices which are named by these IP addresses.

An Autonomous System (AS) refers to a collection of one or more routers that are under one administrative authority that use a common Interior Gateway Protocol for routing purposes. The Internet is composed of tens of thousands of autonomous systems that are under separate administrative authorities (domains). Inter-domain advertising of routes among various ASes is performed using BGP as described below.

Border Gateway Protocol (BGP) refers to an inter-domain dynamic routing protocol. BGP is a path vector protocol in that a BGP update includes a list of autonomous systems which describe one or more paths to one or more destination addresses. A destination is either announced by the owner of an IP address if it runs BGP and has an Autonomous System (AS) number, or by the owner's upstream provider AS. BGP has no authentication mechanism.

IP address hijacking occurs in various forms in the control plane by taking advantage of the inter-domain routing, e.g., using BGP, without authentication. For example, an attacker may announce an attractive AS path that may not exist in reality. Upon receiving these fabricated advertisements, other BGP routers may be fooled into thinking that a better route has become available towards the target and start forwarding future traffic along the false path. As a result of the hijacking, part (if not all) of the traffic addressed to the target may be forwarded to the attacker instead of the target prefix.

Prefix hijackings may be classified into three categories based on how the attacker deals with the hijacked traffic. The three categories are:

Blackholing;

Imposture; and

Interception.

Blackholing refers to an attack in which the attacker drops the attracted packets. Imposture refers to an attack in which the attacker responds to senders of the hijacked traffic, mimicking the true destination's (the target prefix's) behavior. Interception refers to an attack in which the attacker forwards the hijacked traffic to the target prefix after eavesdropping/recording the information in the packets.

The current invention uses the term “hijack” to refer to all of these types of behaviors. Also, the current invention uses the terms attacker and hijacker interchangeably.

While the conventional view of the damage of prefix hijacking is focused on blackholing, the other two types of hijacking are equally important, if not more damaging. The most serious consequence of blackholing is a loss of reachability. Blackholing may not be accompanied by other dangers such as a breach of confidentiality. Blackholing may be detected by peers of a hijacked prefix. For example, the communication peers of a target prefix may detect a blackholing attack if they do not receive any response from the target prefix for a period of time, especially if such loss of communication does not occur to the peers of the target prefix.

Imposture and interception are more challenging to detect than blackholing. From any peer's point of view, the target is still reachable. For example, in Multiple Origin ASes (MOAS), a prefix may be legitimately announced by multiple origin ASes. A hijack may not be distinguishable from a legitimate routing change of an MOAS since both may appear as a change of origin AS. Because they are hard to detect, the interception and imposture hijacks may last a long period of time before being detected and/or reported to authorities and/or the target IP address' owner. Furthermore, the hijacker may potentially cause more damage by conducting further attacks such as those similar to online phishing (with correct address as opposed to the normal phishing), sending spam emails, or performing denial of service attacks. In another example, a hijacker may intercept the traffic to retrieve important information for malicious purposes.

Given the threats of interception and imposture hijacks and the much greater challenges of detecting them than detecting blackholing, the current invention presents a method for the detection of imposture and interception hijacks. It should be mentioned that the detection scheme of the current invention is not limited to detecting imposture and interception hijacks, nor is it restricted to detecting IP prefix hijacking. Rather, the method may be implemented to detect some other types of misbehavior, e.g., faking a Domain Name Server (DNS) response.

The method is motivated by two observations of behaviors of non-hijacked prefixes. The first observation is that the hop count of a path from a source location to a non-hijacked prefix is generally stable. This is mainly due to the fact that an IP prefix assignment on the Internet is performed on a long term basis. Once an IP prefix is assigned, it may be announced either by the prefix owner if it runs BGP, or by its immediate upstream service provider AS(es). In either case, the network location of the prefix viewed from external vantage points should belong to the same topological region.

Due to Internet's vast size, network topological dynamics such as link status changes dramatically affect only a fraction of the overall Internet topology. Because routes are constructed based on the actual network topology of the Internet, network distance measurements obtained from the data plane, reflect the network distances in the actual network topology. The network distance measurements are indeed network distances in the routing topology configured by BGP and other routing protocols. Hence, the network distance measured from a given vantage point to a destination network is likely to remain the same over time.

The second observation is that the path from the source location to a non-hijacked prefix is almost always a super-path of the path from the same source location to a reference point along the previous path, as long as the reference point is topologically close to the prefix. By carefully selecting multiple vantage points and monitoring from these vantage points for any departure from these two observations, the current method is able to detect prefix hijacking with high accuracy in a light-weight, distributed, and real-time fashion. The distributed nature of the scheme enables multiple monitoring devices to work collaboratively, improving system robustness and spreading out monitoring traffic overhead over the Internet.

If a prefix is hijacked, the association between the routes to the prefix and the underlying network topology disappears. Thus, the network distances measured from certain vantage points to the target prefix would likely exhibit significant differences from what these distances were prior to the hijacking. In imposture scenarios, the network distances from certain vantage points to the target prefix may appear to be either shorter or longer, depending on the network locations of the vantage points and the network locations of the attackers. In interception scenarios, it is more likely that the network distances from certain vantage points to a target prefix appear to be longer because the paths towards the target prefix now take a detour going through the attacker's AS. Due to the size of the Internet, it is unlikely that the attacker's location is close to the victim's location. Therefore, prefix hijacking may be detected if significant changes in the network distances from certain vantage points to the target prefix are observed.

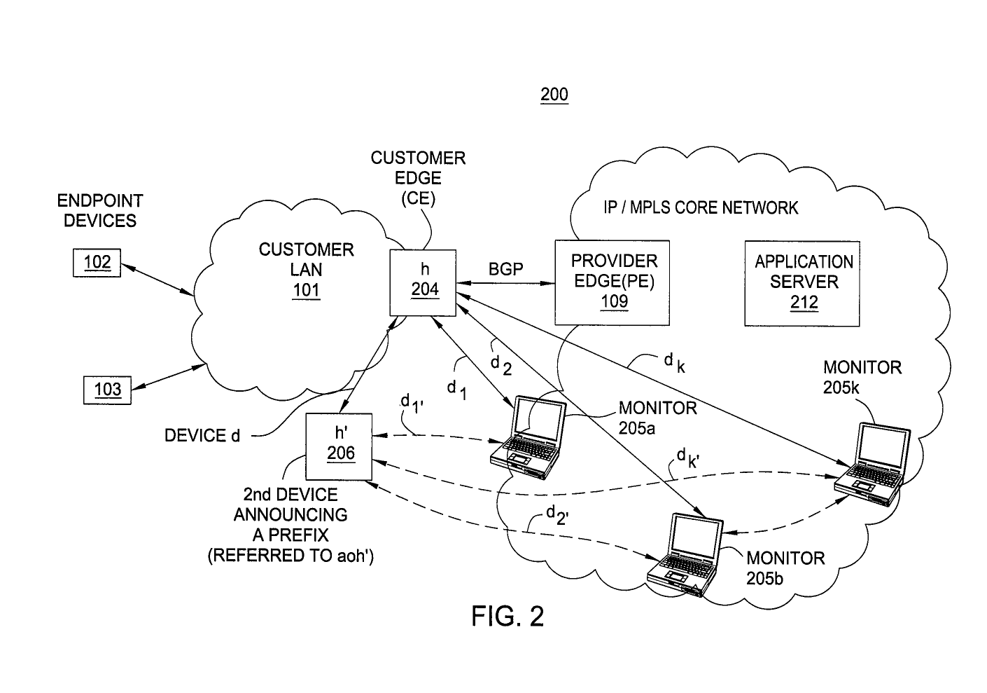

FIG. 2 illustrates an exemplary network 200 for providing detection of address hijacking. For example, customer endpoint devices 102-103 are accessing services from IP/MPLS core network 110 via a customer LAN 101. The customer LAN 101 also contains Customer Edge (CE) router 204 with BGP functionality. The IP/MPLS core network also comprises monitors 205a-205k and an application server 212 for detecting IP address hijackings. Monitor refers to a network device that probes a network location of a target prefix. Each monitor provides a different vantage point. In one embodiment, the service provider implements the current method for detecting hijackings in the application server 212. The application server 212 is in communication with monitors 205a-205k, to receive data for detection of hijackings.

To illustrate, the CE router 204 accesses the IP/MPLS core network 110 via a Provider Edge (PE) router 109 located at the edge of the IP/MPLS core network 110. The device announcing the prefixes for the customer via the BGP plane is CE 204, also referred to as h. Device 206 is a second device announcing a prefix and is referred to as h′. Monitors 205a-205k provide k vantage points for monitoring a target prefix (i.e. the customer's prefix).

Suppose that the prefix for the customer is previously announced by h. The network distance between a vantage point i and h is denoted by dᵢ. Now, suppose h′ also announces the same prefix. The distance between the vantage point i and h′ is denoted as d′ᵢ. Then, the distance d between h and h′ is bounded by d≧maxᵢ₌₁^{k}|dᵢ−d′ᵢ|. If h and h′ are co-located d would be small. For example, h′ may be a provider or a customer of h, or h and h′ may both be service providers for the owner of the prefix (customer). Therefore, dᵢ≈d′ᵢ for (i=1, . . . , k). However, in the scenarios of imposture where h′ hijacks the prefix, with high probability h and h′ are not co-located. Mathematically defined, ∃iε1, . . . , k such that |dᵢ−d′ᵢ|≧δ, where δ may be considered as a detection threshold. Therefore, the value of D≧maxᵢ₌₁^{k}|dᵢ−d′ᵢ| is an indication of the likelihood of a prefix being hijacked. The larger D is, the more likely the prefix is hijacked. For the case of interception, the distance from a vantage point i to the prefix would be d′ᵢ+d. Such attack scenarios may be detected with high probability as long as ∃iε1, . . . , k such that |dᵢ−d′ᵢ+d|≧δ.

It is important to note that the service provider may establish multiple topologically diverse vantage points for effectively monitoring a target prefix. Using multiple vantage points also increases the difficulty for an attacker to conduct any countermeasures because the attacker would have to circumvent the multiple vantage points. In addition, the multiple vantage points may reduce false positive ratios.

To formulate the monitor (vantage point) selection problem, the method first defines a correlation between a pair of paths as the number of common links between the two paths over the length of the shorter path. If there is no shared link, the correlation is zero. On the other hand, if the two paths are identical or one path is a sub-path of the other, their correlation is 1. The correlation between two sets of paths is defined as the maximum path correlation between any two paths, one from each path set.

In one embodiment, the monitor selection problem is then constructed as a hierarchical clustering problem. Such problems have well-known algorithms that are polynomial-time complex. First, the method starts with M clusters, with each candidate monitor being a single item cluster. The method then computes the correlations for all possible cluster pairs. Second, the method identifies the two clusters with the largest correlation among all cluster pairs, and merges these two clusters into a single cluster. Third, the method re-computes the correlations between all cluster pairs again. Then, the method repeats steps two and three until there are only m clusters. At the end of the selection of m clusters, the method randomly selects one monitor from each of the m clusters to identify the m desired monitors to be used in monitoring the service for the target prefix.

In one embodiment, the method then uses the selected monitors to monitor network distances of the target prefix. For example, each monitor measures hop counts. Mathematically defined, the hop count change detection may be viewed as a time series change detection method with a fixed sized sliding window of S data points. Only data points obtained within this time window are taken into consideration. For example, the moving average is calculated as:

$$a = \frac{1}{S} {\sum }_{i = n - S + 1}^{n} {h}_{i} ,$$

where, hᵢ is the i-th hop count, S is the sliding window size, and the n-th measurement is the newest measurement.

In one embodiment, if a new hop count measurement departs dramatically from the previous moving average, the method raises a flag indicating underlying pattern change. If multiple monitors discover significant hop count distance changes at the same time, the change indicates that the topological location of the target prefix on the Internet has changed.

In practice, there may be transient problems that affect hop count measurements. In one embodiment, the current invention uses a second sliding window for smoothing the hop count measurements and/or a filtering technique to filter out transient spikes in hop count measurements.

In one embodiment, the method denotes the first sliding window (described above) by W₁. The method then uses another sliding window W₂ to smooth out current hop count measurement. The sizes of these two windows are S₁ and S₂, respectively. For example, S₁ and S₂ may be 12 and 10, respectively. S₁ should be greater than S₂, because S₁ represents the past average hop count and W₂ is only used to smooth out measurement errors and what kind of transient problems are dominant, and how well the transient problems should be handled. When the network is stable, W₂'s moving average

hop count

$${a}_{2} = \frac{1}{{S}_{2}} {\sum }_{h in {W}_{2}}^{ } h$$

is very close to W₁'s moving average hop count

$${a}_{1} = \frac{1}{{S}_{1}} {\sum }_{h in {W}_{1}}^{ } h .$$

On the other hand, if the difference between these two averages is significant, the location of the target prefix has just changed. Therefore, a hijacking may be detected and/or reported based on a threshold T as follows. A hijacking is detected if,

$$\frac{max \{ {a}_{1} , {a}_{2} \}}{min \{ {a}_{1} , {a}_{2} \}} \geq T .$$

In one embodiment, the current invention shortens the above time window by a measurement interval if a hop count data is not collected during said measurement interval. For example, if there is no hop count data for 1 measurement interval due to packet loss, the method shortens the corresponding time window size by 1.

The description above focused on detection mechanism for significant network location changes. However, not all significant network location changes are the results of prefix hijackings. For example, the topology of the Internet changes regularly due to reasons such as link status changes and policy-based route changes. Location changes due to link status changes and policy-based route changes are referred to as legitimate changes. That is, in contrast to location changes induced by prefix hijackings, these changes are legitimate. As mentioned before, most legitimate changes are not expected to result in dramatic widespread location changes and are filtered out by the aforementioned location based hijack detection algorithm of the current invention.

However, routes in the Internet are not always configured based on network topology due to special routing policies. In this case, the inherent stability of the network topology of the Internet does not translate to stability in routing topology. Also in rare occasions link status changes may actually alter the Internet topology dramatically. These kinds of routing topology changes may be significant and may be mistakenly identified as hijacking by the location based mechanism.

In one embodiment, the current invention provides a path disagreement detection method for differentiating between legitimate route changes and changes due to prefix hijackings. The path disagreement detection method is used in conjunction with the network location monitoring to increase the accuracy of the results. The path disagreement detection focuses on one particular difference between legitimate route changes and prefix hijacking attack induced route changes: the portion of the network being affected. A prefix hijacking attack usually only targets a specific network prefix while legitimate route changes affect a larger number of prefixes.

For each monitor, the method first identifies one reference point along the path from the monitor to the target prefix. This reference point is selected such that: the reference point is topologically close to the target prefix but still has an IP address outside of the target IP prefix. Because of the topological closeness (from the same monitor), the route to the reference point of a target prefix is very likely to be a portion of the route to the target prefix. Also, for the same reason, legitimate route changes in the Internet would affect the target prefix and its reference point equally. On the other hand, because the reference point has an IP address outside of the target prefix, any prefix hijacking attacks targeting the prefix will not affect the reference point. Hence, the method detects disagreement between the path from a monitor to a target prefix and the path from the same monitor to the corresponding reference point of the target prefix. Significant disagreement indicates a prefix hijacking attack at the target prefix.

In one embodiment, the reference point for a monitor is either on a CE router connected to the service provider's network or the PE router (customer facing interface of the service provider's network). Note that if a reference point is not immediately connected to the target prefix, then a portion of the Internet may lie between the target prefix and the reference point. If a hijacker is located within this portion of the Internet, the monitor may not see any path disagreement. This is because the path to the reference point is still a portion (sub-path) of the path to the target prefix. In one embodiment, the service provider may select the reference point as close to the target prefix as possible to reduce this undesirable behavior.

In one embodiment, a candidate reference point is identified by retreating along the route from the monitor to the target prefix backwards hop by hop to the first location that may be used for the hijack detection operation. For example, a trace-route may be performed from the monitor to the target prefix to discover the routers traversed on the path between the monitor and the target prefix. The method may then select the router closest to the target prefix that may assist with detection of address hijackings.

Those skilled in the art would realize reference points need to be established on a per monitor basis. The reason is that the reference point selected for one monitor may not be on the path from a different monitor to the same prefix.

In some network scenarios, e.g., networks with multi-homed target prefixes, a legitimate route change may cause the monitor's probe traffic to reach the target prefix via a difference access router. The new path to the target prefix may be quite different from the path to its current reference point.

In one embodiment, the current invention establishes reference points for a target prefix on a per-monitor basis and on a per-access router basis. For example, a monitor is enabled to know all of its reference points for the target prefix, with each reference point corresponding to an access router of the target prefix. Once an instance of a path disagreement is detected, the monitor compares the path to the target prefix with paths to all of the monitor's reference points. If the path to the target prefix differs from all of these paths to reference points, the path change is detected as a prefix hijacking attack.

For example, for a target prefix, the current method selects a number of monitors from a set of candidate monitors that are most suitable for conducting monitoring operations for the target prefix. The method then uses the selected monitors for measuring the network distance to said target prefix. The method may then continuously monitor the network location of said target prefix from multiple vantage points (the selected monitors) by measuring the network distance from each selected monitor to the target prefix. For example, the selected monitors may send traceroute packets to said target prefix and perform distance measurements. Traceroute refers to a utility command that records the route (e.g., gateway devices such as routers) through the Internet between an origination address and a destination address.

In one embodiment, one or more of the selected monitors may then detect and/or report changes in hop count distance measurement from said monitors to the target prefix. In one embodiment, the selected monitors send trace data to an application server that performs hijack detection from a centralized location. In another embodiment, the monitors detect the hijacking and report alarms.

In one embodiment, if a significant change is detected in distance measurements, the monitor measures the disagreement between the path to the target prefix and the path(s) to the reference point(s) of the target prefix. If a network location change is indeed detected, the method then determines if the location change is caused by a legitimate route change. If there is a significant disagreement between paths and it is not due to a legitimate route change, the method may then send an alarm for hijack detection for said target prefix.

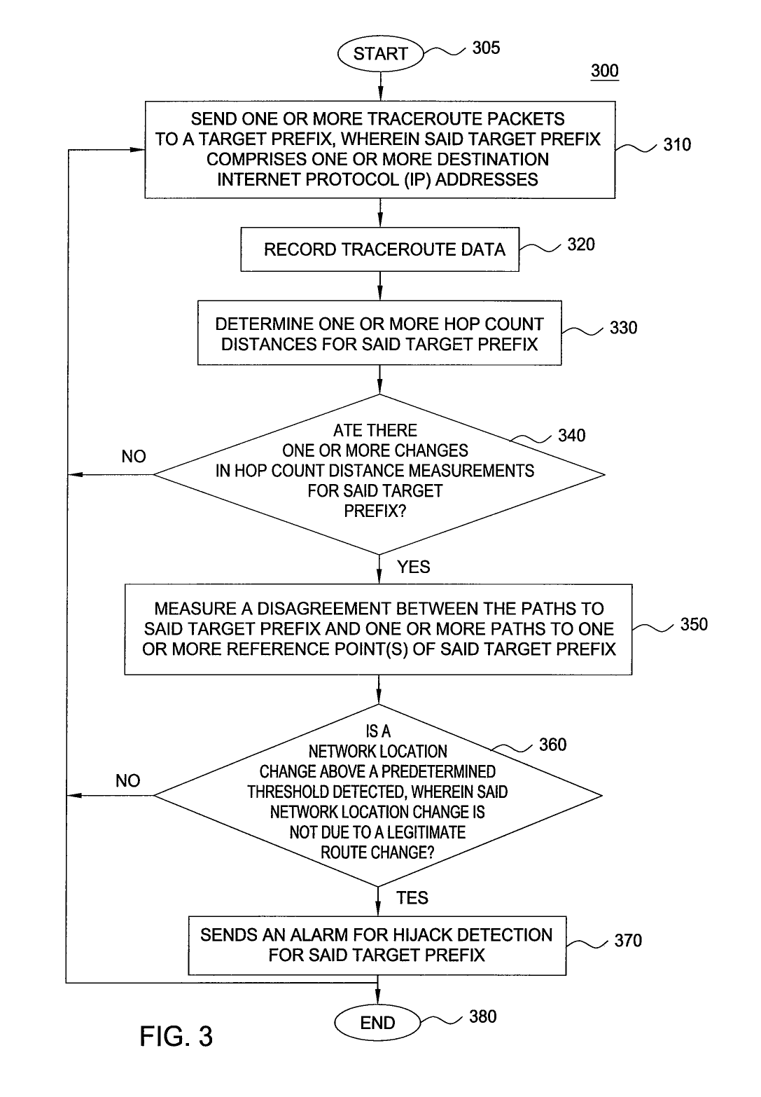

FIG. 3 illustrates a flowchart of a method 300 for providing detection of address hijacking. For example, one or more steps of method 300 can be implemented by a monitor. Method 300 starts in step 305 and proceeds to step 310.

In step 310, method 300 sends one or more traceroute packets to a target prefix, wherein the target prefix comprises one or more destination Internet Protocol (IP) addresses. For example, a monitor may send traceroute packets to one or more IP addresses that are being monitored for detection of IP address hijackings.

In step 320, method 300 records traceroute data. For example, the method receives and records the results of traceroute commands for the IP addresses in the target prefix.

In step 330, method 300 determines one or more hop count distances for the target prefix. For example, the method calculates hop counts for each IP address in the target prefix.

In step 340, method 300 determines if there are one or more changes in hop count distance measurements for the target prefix. If there are one or more changes the method proceeds to step 350. Otherwise, the method proceeds to step 310.

In step 350, method 300 measures a disagreement between the paths to the target prefix and one or more paths to one or more reference point(s) of the target prefix. For example, a monitor measures the hop count distance between itself and the reference point of the target prefix.

In step 360, method 300 determines whether or not a network location change above a predetermined threshold is detected, wherein the network location change is not due to a legitimate route change. For example, the method may determine if the route change affected both the target prefix and the reference point or just the target prefix. If a network location change that is not due to a legitimate route change is detected, the method proceeds to step 370. Otherwise, the method proceeds to step 310.

In step 370, method 300 sends an alarm for hijack detection for the target prefix. The method then ends in step 380 or returns to step 310 to continue monitoring.

In one embodiment, the one or more of the steps of the method 300 may also be performed by an application server that receives traceroute data from one or more monitoring devices. For example, the traceroute data may be gathered at a centralized location and hop count measurements and hijack detection may be performed at the centralized location.

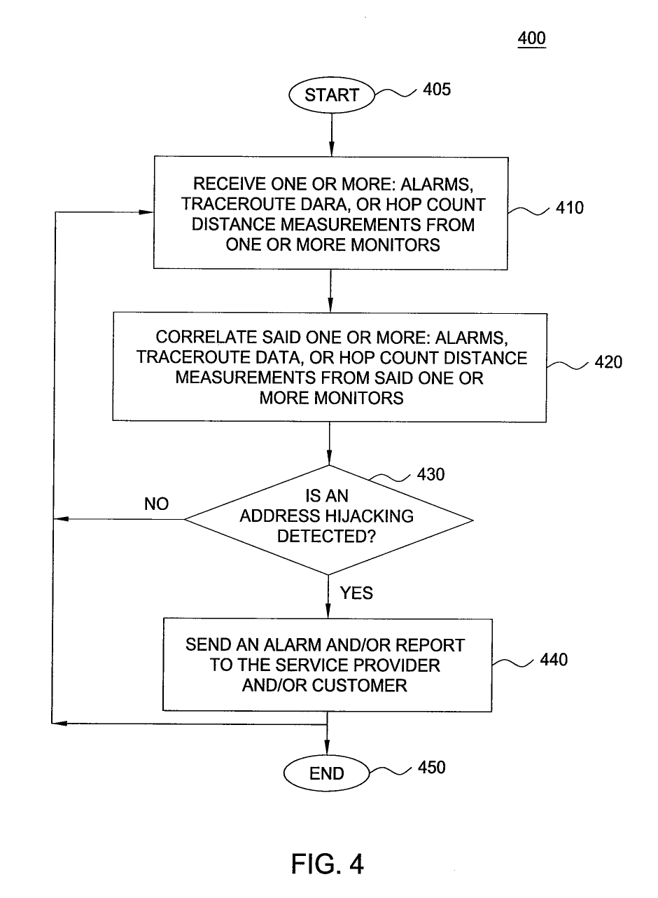

FIG. 4 illustrates a flowchart of a method 400 for providing detection of address hijacking. For example, one or more steps of method 400 can be implemented by an application server. Method 400 starts in step 405 and proceeds to step 410.

In step 410, method 400 receives one or more: alarms, traceroute data, or hop count distance measurements from one or more monitors. For example, a service provider may enable a target prefix to be monitored by multiple monitoring devices that provide different vantage points. The monitors may be providing the raw traceroute data, calculated hop count distance measurements or alarms to the application server.

In step 420, method 400 correlates the one or more: alarms, traceroute data, or hop count distance measurements from the one or more monitors. For example, a target prefix may have two monitors providing hop count distance measurements to the application server. The application server then correlates the hop count distance measurements it receives for the target prefix.

In step 430, method 400 determines whether or not an address hijacking is detected. For example, the method may detect a route change but it may be for a legitimate change. In another example, the method may detect a route change due to an address hijacking. If an address hijacking is detected for the target prefix, the method proceeds to step 440. Otherwise, the method proceeds to step 410.

In optional step 440, method 400 sends an alarm and/or report to the service provider and/or customer. The method then ends in step 450 or returns to step 410 to continue receiving data.

In one embodiment, the current method determines the similarity between two autonomous system paths starting from the same origin but ending at two different destinations by determining a Hamming distance as described below.

Given two paths, P₁ and P₂, such that the path length of P₁ is greater than or equal to that of P₂, i.e. |P₁|≧|P₂|, the method identifies a sub-path of P₁, P′₁, which starts from the same origin as P₁ but has length of |P₂″. Then, the method determines the Hamming distance between P′₁ and P₂, and denotes the distance as d. Similarly, s is then defined as:

$$s = 1 - \frac{d}{\vert {P}_{2} \vert} .$$

The subtraction from 1 makes s follow the convention of “similarity”; that is, the larger the Hamming distance is, the less similar two paths are. Once a potential hijack is reported from the location change detection algorithm, the method may further check if there is still significant similarity between the path from the monitor to the target prefix and the path from the same monitor to the corresponding reference point of the target prefix.

In one embodiment, the method may then compare the path similarities before and after the reported potential hijack to determine if the similarity has decreased significantly. The monitor may then report an alarm if the path similarity decreases above a predetermined threshold, e.g., a percentage value (e.g., 80% and so on). It should be noted that the thresholds can be selectively set to meet the requirement of a particular implementation. The service provider determined the threshold for a significant decrease in path similarity.

It should be noted that although not specifically specified, one or more steps of methods 300 and 400 may include a storing, displaying and/or outputting step as required for a particular application. In other words, any data, records, fields, and/or intermediate results discussed in the methods 300 and 400 can be stored, displayed and/or outputted to another device as required for a particular application. Furthermore, steps or blocks in FIG. 3 or FIG. 4 that recite a determining operation, or involve a decision, do not necessarily require that both branches of the determining operation be practiced. In other words, one of the branches of the determining operation can be deemed as an optional step.

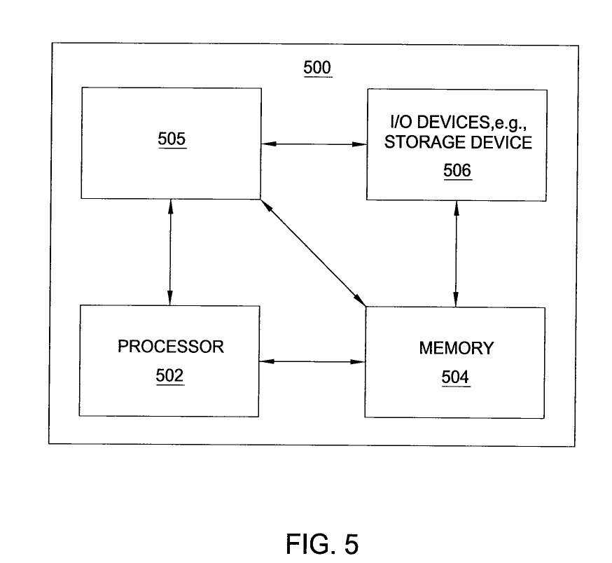

FIG. 5 depicts a high-level block diagram of a general-purpose computer suitable for use in performing the functions described herein. As depicted in FIG. 5, the system 500 comprises a processor element 502 (e.g., a CPU), a memory 504, e.g., random access memory (RAM) and/or read only memory (ROM), a module 505 for providing detection of address hijacking in a network, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 505 for providing detection of address hijacking in a network can be loaded into memory 504 and executed by processor 502 to implement the functions as discussed above. As such, the present method 505 for providing detection of address hijacking in a network (including associated data structures) of the present invention can be stored on a computer readable medium, e.g., RAM memory, magnetic or optical drive or diskette and the like. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for detecting an address hijacking in a network, comprising:
sending one or more traceroute packets to a target prefix, wherein said target prefix comprises one or more destination Internet Protocol (IP) addresses;
recording traceroute data received for said one or more traceroute packets sent to said target prefix;
determining one or more hop count distance measurements for said target prefix; and
determining if there are one or more changes in said one or more hop count distance measurements for said target prefix.

2. The method of claim 1, further comprising:
sending an alarm if there are one or more changes in said one or more hop count distance measurements for said target prefix.

3. The method of claim 1, further comprising:
measuring a disagreement between paths to said target prefix and one or more paths to one or more reference points of said target prefix, if there are one or more changes in said one or more hop count distance measurements for said target prefix.

4. The method of claim 3, further comprising:
determining if a network location change above a predetermined threshold is detected; and
sending an alarm for an address hijack detection for said target prefix if said network location change is not due to a legitimate route change.

5. The method of claim 4, wherein said address hijack detection is for detecting at least one of: a blackholing event, an imposture event, or an interception event.

6. The method of claim 1, further comprising:
removing transient effects in said hop count distance measurements.

7. The method of claim 3, wherein said one or more reference points comprises at least one of: a Customer Edge (CE) router, or a Provider Edge (PE) router connected to said CE router.

8. The method of claim 3, wherein said one or more reference points are established for said target prefix on a per-monitor basis, or on a per-access router basis.

9. A computer-readable medium having stored thereon a plurality of instructions, the plurality of instructions including instructions which, when executed by a processor, cause the processor to perform the steps of a method for detecting an address hijacking in a network, comprising:
sending one or more traceroute packets to a target prefix, wherein said target prefix comprises one or more destination Internet Protocol (IP) addresses;
recording traceroute data received for said one or more traceroute packets sent to said target prefix;
determining one or more hop count distance measurements for said target prefix; and
determining if there are one or more changes in said one or more hop count distance measurements for said target prefix.

10. The computer-readable medium of claim 9, further comprising:
sending an alarm if there are one or more changes in said one or more hop count distance measurements for said target prefix.

11. The computer-readable medium of claim 9, further comprising:
measuring a disagreement between paths to said target prefix and one or more paths to one or more reference points of said target prefix, if there are one or more changes in said one or more hop count distance measurements for said target prefix.

12. The computer-readable medium of claim 11, further comprising:
determining if a network location change above a predetermined threshold is detected; and
sending an alarm for an address hijack detection for said target prefix if said network location change is not due to a legitimate route change.

13. The computer-readable medium of claim 12, wherein said address hijack detection is for detecting at least one of: a blackholing event, an imposture event, or an interception event.

14. The computer-readable medium of claim 9, further comprising:
removing transient effects in said hop count distance measurements.

15. The computer-readable medium of claim 11, wherein said one or more reference points comprises at least one of: a Customer Edge (CE) router, or a Provider Edge (PE) router connected to said CE router.

16. The computer-readable medium of claim 11, wherein said one or more reference points are established for said target prefix on a per-monitor basis, or on a per-access router basis.

17. A method for detecting an address hijacking in a network, comprising:
receiving one or more: alarms, traceroute data, or hop count distance measurements from one or more monitors;
correlating said one or more: alarms, traceroute data, or hop count distance measurements from said one or more monitors; and
determining whether an address has been hijacked for a target prefix.

18. The method of claim 17, further comprising:
sending an alarm to a service provider or a customer, if said address has been hijacked for said target prefix.

19. The method of claim 17, wherein transient effects in said hop count distance measurements are removed.

20. The method of claim 17, wherein said address has been hijacked for a target prefix due to a blackholing event, an imposture event or an interception event.
